(19) United States
(12) Patent Application Publication
(10) Pub. No.: US 2019/0064735 A1
(43) Pub. Date: Feb. 28, 2019

(54) Methods and Apparatus for Compensating Image Distortion and Illumination Nonuniformity in a Waveguide

(71) Applicant: DigiLens, Inc., Sunnyvale, CA (US)

(72) Inventors: Jonathan David Waldern, Los Altos Hills, CA (US); Sihui He, Sunnyvale, CA (US); Alastair John Grant, San Jose, CA (US); Milan Momcilo Popovich, Leicester (GB)

(73) Assignee: DigiLens, Inc., Sunnyvale, CA (US)

(21) Appl. No.: 16/118,328

(22) Filed: Aug. 30, 2018

Related U.S. Application Data
(60) Provisional application No. 62/605,830, filed on Aug. 30, 2017.

(51) Int. Cl. G03H 1/02; G03H 1/04

(52) U.S. Cl. CPC G03H 1/0244; G03H 1/0402; G03H 2001/0439; G03H 2223/16; G03H 2260/12

(57) ABSTRACT

Typical waveguides rely on total internal reflection between the outer surfaces of substrates, which can make them highly susceptible to beam misalignment caused by nonplanarity of the substrates. In the manufacturing of the glass sheets commonly used for substrates, ripples can occur during the stretching and drawing of glass as it emerges from a furnace. Although glass manufacturers try to minimize ripples using predictions from mathematical models, it is difficult to totally eradicate the problem from the glass manufacturing process. Typically, these beam misalignments manifest themselves as image distortions and non-uniformities in the output illumination from the waveguide. Many embodiments of the invention are directed toward optically efficient, low cost solutions to the problem of controlling output image quality in waveguides manufactured using commercially available substrate glass and to the problem of compensating the image distortions and non-uniformity of curved waveguides.

### CROSS-REFERENCE TO RELATED APPLICATIONS

The current application claims the benefit of and priority under 35 U.S.C. § 119(e) to U.S. Provisional Patent Application No. 62/605,830 entitled “Method and apparatus for compensating image distortion and illumination nonuniformity in a waveguide,” filed Aug. 30, 2017. The disclosure of U.S. Provisional Patent Application No. 62/605,830 is hereby incorporated by reference in its entirety for all purposes.

### FIELD OF THE INVENTION

The present invention generally relates to waveguides and, more specifically, to holographic waveguides.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for Augmented Reality (“AR”) and Virtual Reality (“VR”), compact Heads Up Displays (“HUDs”) for aviation and road transport, and sensors for biometric and laser radar (“LIDAR”) applications.

### SUMMARY OF THE INVENTION

One embodiment includes a waveguide including a first substrate having first and second surfaces with a surface relief characteristic along a first direction on at least one of the surfaces of the first substrate, a second substrate having first and second surfaces with a surface relief characteristic along a second direction on at least one of the surfaces of the second substrate, and at least one optical layer for modifying at least one of phase, amplitude, and propagation direction of light in contact with the second surface of the first substrate and the first surface of the second substrate, wherein the first and second substrates are configured to confine light to a total internal reflection path.

In another embodiment, the surface relief characteristic of the first substrate includes a one-dimensional cyclic function.

In a further embodiment, the surface relief characteristics of the first and second substrates include one-dimensional cyclic functions offset by half a cycle.

In still another embodiment, the surface relief characteristics of the first and second substrates include one-dimensional cyclic functions in phase.

In a still further embodiment, the surface relief characteristic of the first substrate includes at least one sinusoidal frequency.

In yet another embodiment, the first and second surfaces of the first and second substrates each have a surface relief characteristic described by a one-dimensional cyclic function.

In a yet further embodiment, the first and second substrates are curved.

In another additional embodiment, the first substrate includes a rectangular substrate and the first direction is parallel to an edge of the rectangular substrate.

In a further additional embodiment, the first substrate is manufactured using a glass drawing process.

In another embodiment again, the first direction and the second direction are separated by ninety degrees.

In a further embodiment again, the first direction and the second direction are parallel.

In still yet another embodiment, the optical layer forms a wedge.

In a still yet further embodiment, the optical layer includes at least one grating.

In still another additional embodiment, the at least one grating includes a grating selected from the group consisting of a Bragg grating recorded in a holographic photopolymer and a switchable Bragg grating recorded in a holographic polymer dispersed liquid crystal.

In a still further additional embodiment, the waveguide contains a stratified index or gradient index structure.

In still another embodiment again, the waveguide further includes a polarization control layer.

In a still further embodiment again, the waveguide further includes a liquid crystal alignment layer.

In yet another additional embodiment, the waveguide provides one of a Head Mounted Display a Heads Up Display, an eye-slaved display, a dynamic focus display or a light field display.

A yet further additional embodiment includes a method of fabricating a waveguide, the method includes providing a first optical substrate with a surface relief having a cyclical characteristic along a first direction, providing a second optical substrate with a surface relief having a cyclical characteristic along a second direction, forming a cell from the first optical substrate and the second optical substrate, wherein the second optical substrate overlaps the second optical substrate, filling the cell with an optical recording medium to form an unexposed optical layer, and applying an optical exposure process to the unexposed optical layer.

A yet another embodiment again includes a method of fabricating a waveguide, the method includes providing a first optical substrate with a surface relief having a cyclical characteristic along a first direction, providing a second optical substrate with a surface relief having a cyclical characteristic along a second direction, applying an unexposed optical layer to the first optical substrate, applying an optical exposure process to the unexposed optical layer, and covering the optical layer with the second optical substrate, wherein the second substrate overlaps the first substrate.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a cross sectional view of a waveguide in accordance with an embodiment of the invention.

FIG. 2 conceptually illustrates a cross sectional view of a waveguide in accordance with an embodiment of the invention.

FIG. 3 conceptually illustrates a plan view of a portion of a waveguide substrate showing surface relief contours and a principal direction along which the surface relief varies in accordance with an embodiment of the invention.

FIG. 4 conceptually illustrates a cross sectional view of a portion of the waveguide of FIG. 3 showing the surface relief and a principal direction along which the surface relief varies in accordance with an embodiment of the invention.

FIG. 5 conceptually illustrates a schematic view showing surfaces of the first and second substrates of a waveguide indicating the directions along which the surface relief varies in each substrate in accordance with an embodiment of the invention.

FIG. 6 conceptually illustrates a schematic view showing surfaces of the first and second substrates of a waveguide in which the directions along which the surface relief varies in each substrate are orthogonal in accordance with an embodiment of the invention.

FIG. 7 conceptually illustrates a cross sectional view of a portion of a waveguide substrate in which the surface in contact with the optical layer has a surface relief and the outer surface is planar in accordance with an embodiment of the invention.

FIG. 8 conceptually illustrates a cross sectional view of a portion of a waveguide substrate in which the surface in contact with the optical layer is planar and the outer surface has a surface relief in accordance with an embodiment of the invention.

FIG. 9 conceptually illustrates a cross sectional view of a portion of a waveguide substrate in which both the surface in contact with the optical layer and the outer surface of the waveguide have a surface relief in accordance with an embodiment of the invention.

FIG. 10 conceptually illustrates a cross sectional view of a portion of a curved waveguide substrate in which the surface in contact with the optical layer has a curvature with a surface relief and the outer surface is has curvature without a surface relief in accordance with an embodiment of the invention.

FIG. 11 conceptually illustrates a cross sectional view of a portion of a curved waveguide substrate in which the surface in contact with the optical layer has a curvature without a surface relief and the outer surface has a curvature with a surface relief in accordance with an embodiment of the invention.

FIG. 12 conceptually illustrates a cross sectional view showing the relative disposition of the substrates in a portion of a waveguide in accordance with an embodiment of the invention in which the surfaces of the substrates in contact with the optical layer are planar and the outer surfaces have surface reliefs configured to be in phase along the waveguide.

FIG. 13 conceptually illustrates a cross sectional view showing the relative disposition of the substrates in a portion of a waveguide in accordance with an embodiment of the invention in which the surfaces of the substrates in contact with the optical layer are planar and the outer surfaces have surface reliefs configured to be displaced by half of one cycle along the waveguide.

FIG. 14 conceptually illustrates a flow chart illustrating a method of fabricating a waveguide in accordance with an embodiment of the invention in which the surface relief substrates are formed into a cell which is filled by an optical recording medium prior to subjecting the cell to an optical exposure process to form an optical layer.

FIG. 15 conceptually illustrates a flow chart illustrating a method of fabricating a waveguide in accordance with an embodiment of the invention in which a first surface relief substrate is coated with an optical recording medium prior to applying an optical exposure process to form an optical layer which is then covered by a second surface relief substrate.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description, the terms light, ray, beam and direction may be used interchangeably and in association with each other to indicate the direction of propagation of light energy along rectilinear trajectories. Parts of the following description will be presented using terminology commonly employed by those skilled in the art of optical design. For illustrative purposes, it is to be understood that the drawings are not drawn to scale unless stated otherwise.

Waveguide optics is currently being developed for a range of display and sensor applications for which the ability of waveguides to integrate multiple optical functions into a thin, transparent, lightweight substrate is highly desired. This new approach is stimulating new product developments including near-eye displays for Augmented Reality (“AR”) and Virtual Reality (“VR”), compact Heads Up Display (“HUDs”) for aviation and road transport and sensors for Biometric and laser radar (“LIDAR”) applications. A key waveguide technology uses holographic gratings for modifying the amplitude, phase and beam direction of guided light to allow the field of view, eye box, homogeneity and other display parameters to be controlled.

Examples of waveguides for use in displays and sensors are discussed in the following reference documents. The following patent applications are incorporated by reference herein in their entireties: U.S. Pat. No. 9,075,184 entitled “COMPACT EDGE ILLUMINATED DIFFRACTIVE DISPLAY,” U.S. Pat. No. 8,233,204 entitled “OPTICAL DISPLAYS,” PCT Application No.: US2006/043938, entitled “METHOD AND APPARATUS FOR PROVIDING A TRANSPARENT DISPLAY,” PCT Application No.: GB2012/000677 entitled “WEARABLE DATA DISPLAY,” U.S. patent application Ser. No.: 13/317,468 entitled “COMPACT EDGE ILLUMINATED EYEGLASS DISPLAY,” U.S. patent application Ser. No.: 13/869,866 entitled “HOLOGRAPHIC WIDE ANGLE DISPLAY,” and U.S. patent application Ser. No.: 13/844,456 entitled “TRANSPARENT WAVEGUIDE DISPLAY,” U.S. patent application Ser. No.:14/620,969 entitled “WAVEGUIDE GRATING DEVICE,” U.S. patent application Ser. No.: 15/553,120 entitled “ELECTRICALLY FOCUS TUNABLE LENS,” U.S. patent application Ser. No.: 15/558,409 entitled “WAVEGUIDE DEVICE INCORPORATING A LIGHT PIPE,” U.S. patent application Ser. No.: 15/512,500 entitled “METHOD AND APPARATUS FOR GENERATING INPUT IMAGES FOR HOLOGRAPHIC WAVEGUIDE DISPLAYS,” U.S. patent application Ser. No.: 15/543,013 entitled “OPTICAL WAVEGUIDE DISPLAYS FOR INTEGRATION IN WINDOWS,” U.S. Pat. No. 8,224,133 entitled “LASER ILLUMINATION DEVICE,” U.S. Pat. No. 8,565,560 entitled “LASER ILLUMINATION DEVICE,” U.S. Pat. No. 6,115,152 entitled “HOLOGRAPHIC ILLUMINATION SYSTEM,” PCT Application No.: PCT/GB2013/000005 entitled “CONTACT IMAGE SENSOR USING SWITCHABLE BRAGG GRATINGS,” PCT Application No.: PCT/GB2012/000680, entitled “IMPROVEMENTS TO HOLOGRAPHIC POLYMER DISPERSED LIQUID CRYSTAL MATERIALS AND DEVICES,” PCT Application No.: PCT/GB2014/000197 entitled “HOLOGRAPHIC WAVEGUIDE EYE TRACKER,” PCT Application No.: GB2013/000210 entitled “APPARATUS FOR EYE TRACKING,” PCT/GB2015/000274 entitled “HOLOGRAPHIC WAVEGUIDE OPTICAL TRACKER,” U.S. Pat. No. 8,903,207 entitled “SYSTEM AND METHOD OF EXTENDING VERTICAL FIELD OF VIEW IN HEAD UP DISPLAY USING A WAVEGUIDE COMBINER,” U.S. Pat. No. 8,639,072 entitled “COMPACT WEARABLE DISPLAY,” U.S. Pat. No. 8,885,112 entitled “COMPACT HOLOGRAPHIC EDGE ILLUMINATED EYEGLASS DISPLAY,” and PCT Application No.: PCT/GB2016/000181, entitled “WAVEGUIDE DISPLAY.”

Typical waveguides rely on total internal reflection (“TIR”) between the outer surfaces of substrates, which can make them highly susceptible to beam misalignment caused by nonplanarity of the substrates. In the manufacturing of the glass sheets commonly used for substrates, ripples can occur during the stretching and drawing of glass as it emerges from a furnace. The ripples typically run parallel to the draw direction. Commercially available substrates can exhibit wedge up to 30 seconds with a variation of approximately 45 arc seconds over 100 mm. Although glass manufacturers try to minimize ripples using predictions from mathematical models, it is difficult to totally eradicate the problem from the glass manufacturing process. Typically, these beam misalignments manifest themselves as image distortions and non-uniformities in the output illumination from the waveguide.

The growing interest in curved waveguides poses an inverse problem: image angular content coupled into a curved waveguide can become progressively more de-collimated with each successive reflection even for relatively modest substrate curvatures. One solution to correcting the beam distortion is to apply a small perturbation to the curved surface geometry along the waveguide optical path.

As such, many embodiments of the invention are directed toward optically efficient, low cost solutions to the problem of controlling output image quality in waveguides manufactured using commercially available substrate glass and to the problem of compensating the image distortions and non-uniformity of curved waveguides.

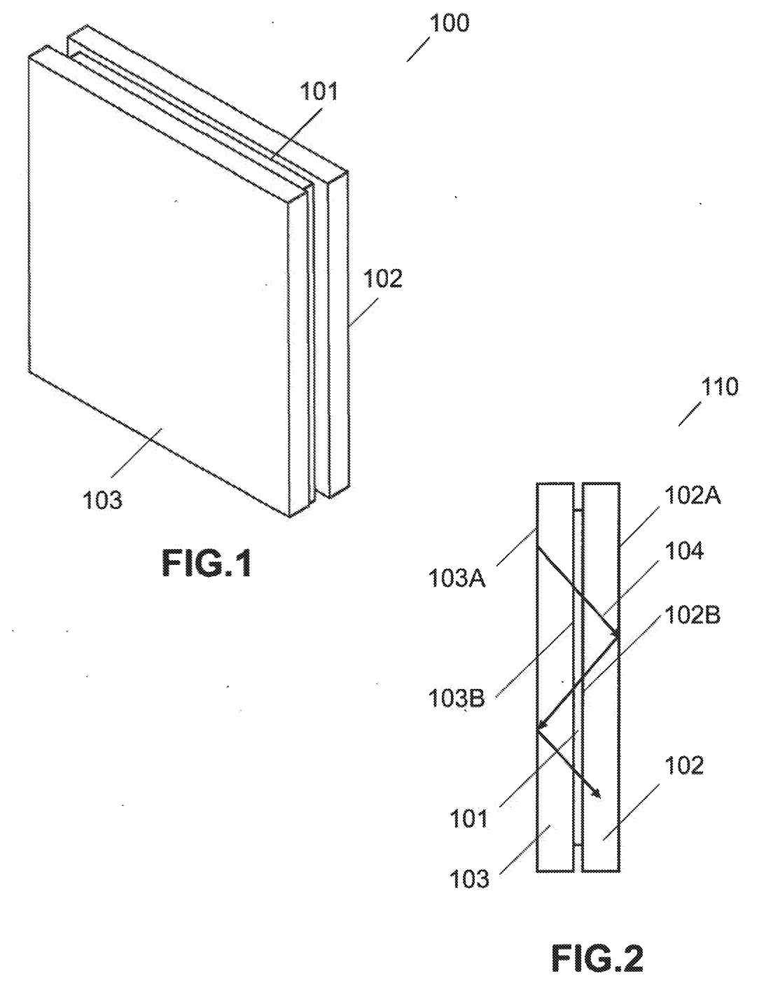

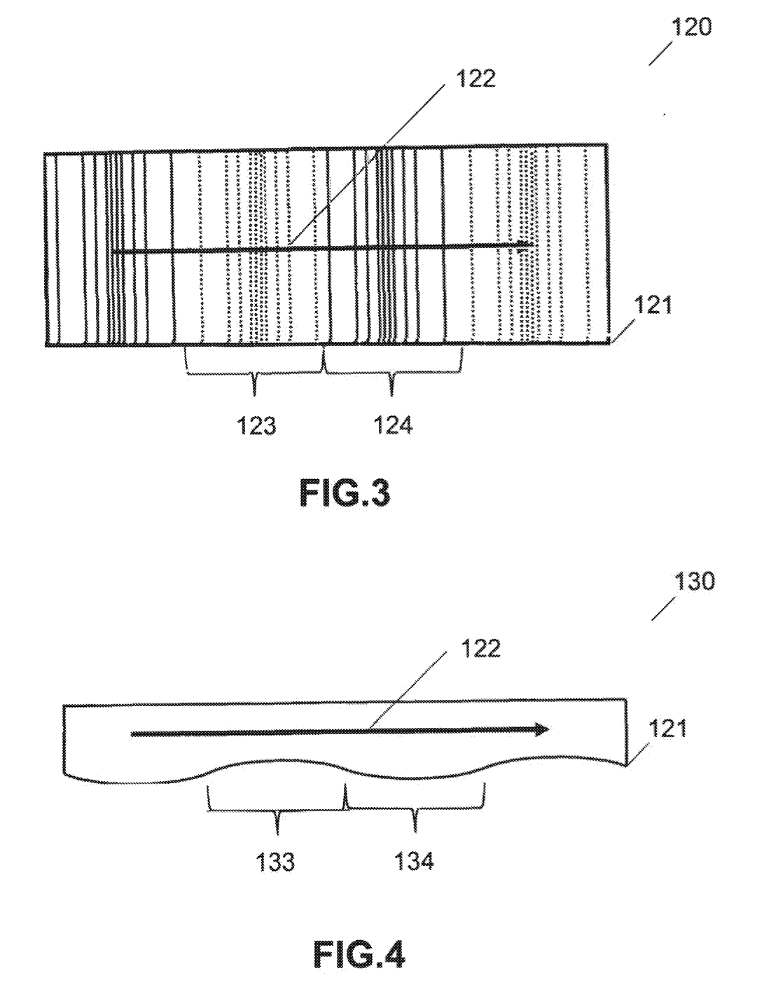

FIGS. 1 and 2 conceptually illustrate a three-dimensional view 100 and a cross-sectional view 110, respectively, of a waveguide in accordance with an embodiment of the invention. In the illustrative embodiment, the waveguide includes a first substrate 102 having first and second surfaces 102A, 102B with a surface relief characteristic along a first direction on at least one of the surfaces, a second substrate 103 having first and second surfaces 103A, 1036 with a surface relief characteristic along a second direction on at least one of the surfaces, and at least one optical layer 101 for modifying at least one of phase, amplitude or propagation direction of light in contact with the second surface of the first substrate and the first surface of the second substrate. As shown in FIG. 2, the substrates 102, 103 are operative to confine light to a total internal reflection path 104. In some embodiments, the substrates are made from glass and the surface relief results from ripples formed in a glass drawing process such as but not limited to the Fourcault process. Typically, the ripples run parallel to the direction of draw.

The surface relief characteristics may be understood more clearly from FIG. 3, which conceptually illustrates a plan view 120 of a substrate portion 121 with the surface relief represented by vertical contour lines. FIG. 4 shows the same surface relief in a cross section 130. As shown in FIGS. 3 and 4, the contours groups 123, 124 correspond to the surface relief minima and maxima 133, 134. The principal direction of surface relief variation is indicated by the vector 122. If not compensated, the guided beam misalignments resulting from the surface relief of the substrates can, in the case of a display waveguide, result in image distortions and non-uniformities in the output illumination from the waveguide.

### Compensation for Surface Relief Variations

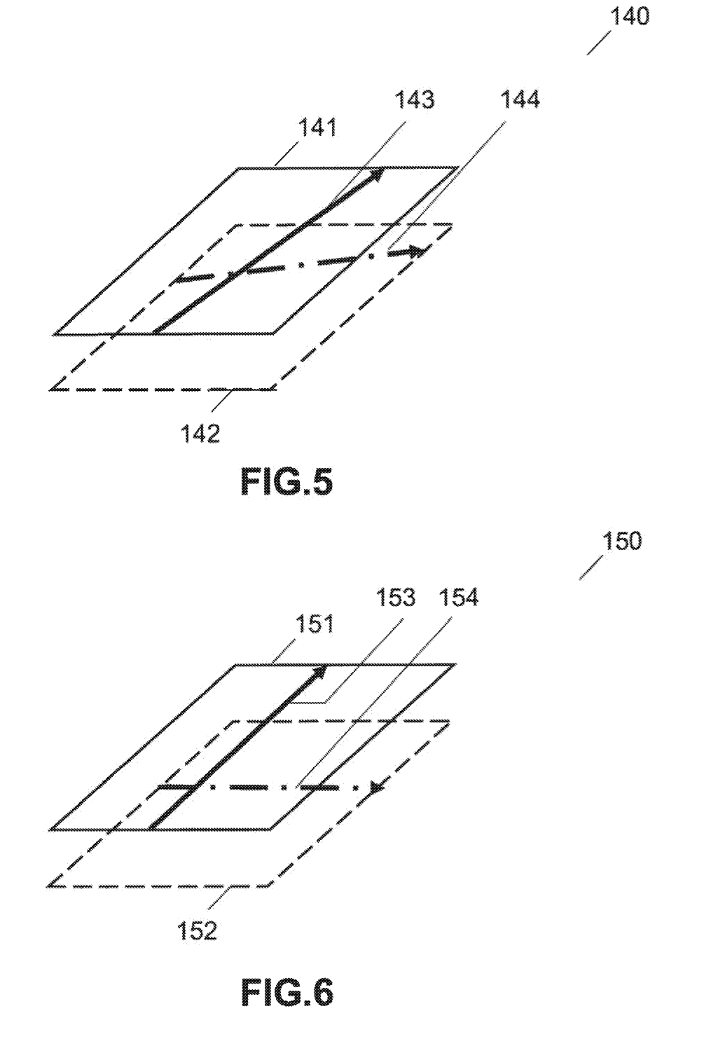

In many embodiments, the compensation for the issues illustrated in FIGS. 3 and 4 can be provided by configuring the substrates such that the principal directions of surface relief in the two substrates are aligned at different angles, as illustrated in FIGS. 5 and 6. FIG. 5 conceptually illustrates a schematic view 140 showing substrate surfaces 141,142 with surface relief variations in the principal directions 143,144 in accordance with an embodiment of the invention. FIG. 6 conceptually illustrates a schematic view of one embodiment 150 in which substrate surfaces 151,152 have principal directions of surface relief variation 153,154 aligned orthogonally, with each direction aligned parallel to a substrate edge.

In many embodiments, the surface relief characteristic is a one-dimensional cyclic function. In some embodiments, the cyclic function is a sinusoid. In a number of embodiments, the surface relief characteristic can be a superposition or Fourier sum of more than one sinusoidal frequency. In several embodiments, the surface relief characteristic can have random variations in amplitude and spatial frequency along the waveguide. In various embodiments, the surface relief can be a two-dimensional cyclic function with a spatial frequency that varies with direction. To simplify the waveguide optical design, a two-dimensional function can be approximated to one dimensional cyclic functions over small regions of the substrate. In some embodiments, the surface relief characteristics of the first and second substrates can differ. In a number of embodiments, the first and second substrates may have cyclic surface relief characteristics with differing spatial frequencies and amplitudes.

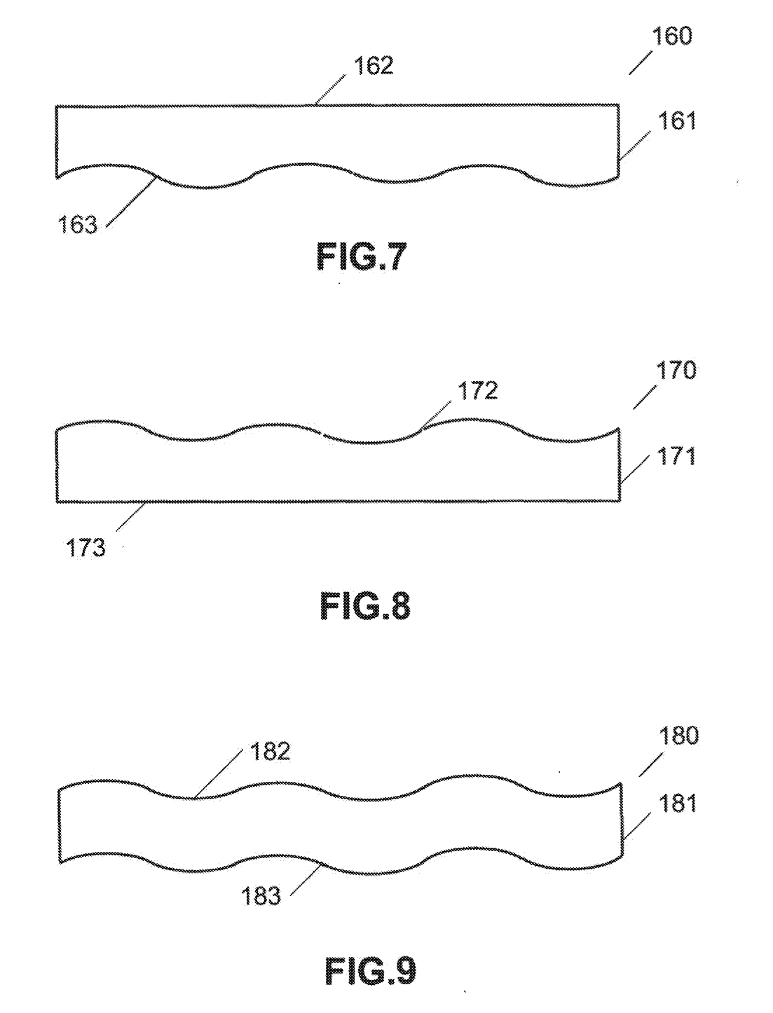

FIGS. 7-9 conceptually illustrate cross-sectional views of portions of various waveguide substrates in accordance with various embodiments of the invention. FIG. 7 shows a cross sectional view 160 of a portion of a waveguide substrate 161 used in some embodiments in which the surface in contact with the optical layer (not shown) 163 has a surface relief and the outer surface 162 is planar. FIG. 8 shows a cross sectional view 170 of a portion of a waveguide substrate 171 used in some embodiments in which the surface in contact with the optical layer (not shown) 173 is planar and the outer surface 172 has a surface relief. FIG. 9 shows a cross sectional view 180 of a portion of a waveguide substrate 181 in which both the surface in contact with the optical layer (not shown) 172 and the outer surface 182 have a surface relief.

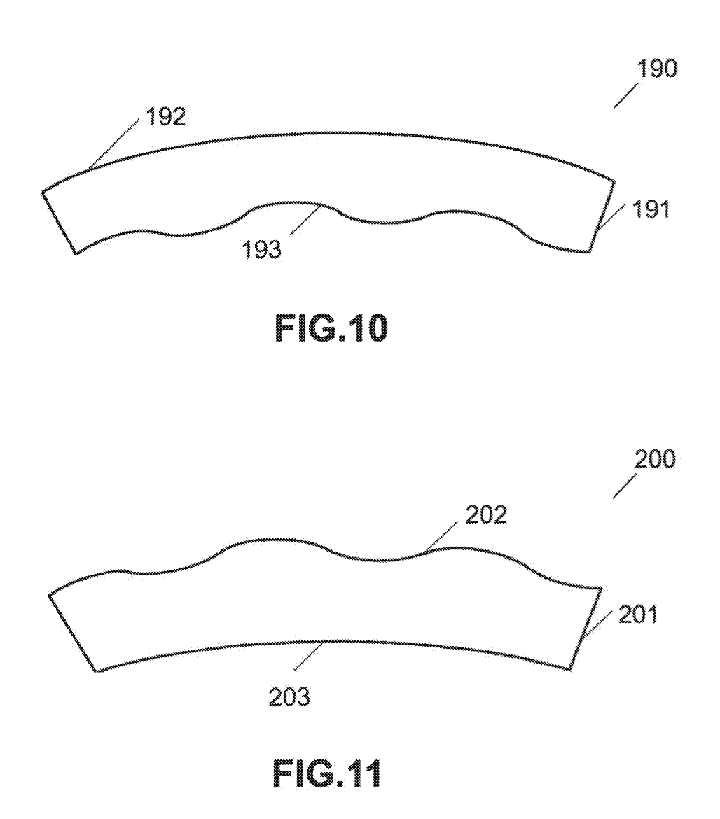

Waveguides based on any of the above-described embodiments can be implemented using plastic substrates. In some embodiments, the plastic substrates can be fabricated using the materials and processes disclosed in PCT Application No.: PCT/GB2012/000680, entitled “IMPROVEMENTS TO HOLOGRAPHIC POLYMER DISPERSED LIQUID CRYSTAL MATERIALS AND DEVICES.” In many embodiments, the waveguide can be curved. In several embodiments, the surface relief characteristics can be based on a prescription designed to correct distortions and non-homogeneity produce by light propagation in a curved waveguide. The surface relief characteristics can be applied to a plastic substrate using a compression molding process. FIGS. 10 and 11 conceptually illustrate curved waveguides designed to correct the beam distortion and illumination non-uniformity resulting from decollimation of wave guided light in accordance with various embodiments of the invention. In each case, the distortion and non-uniformity can be compensated by applying a small perturbation to the curved surface geometry along the waveguide optical path. FIG. 10 is a cross sectional view 190 of a portion of a curved waveguide substrate 191 in which the surface in contact with the optical layer (not shown) 193 has a curvature with a surface relief and the outer surface has a curvature without a surface relief 192. FIG. 11 is a cross sectional view 200 of a portion of a curved waveguide substrate 201 in which the surface in contact with the optical layer (not shown) 203 has a curvature without a surface relief and the outer surface has a curvature with a surface relief 202. In some embodiments, a waveguide according to the principles of the invention can contain a gradient index structure, which can be based on GRIN material or a stratified refractive index architecture. Such a waveguide can use the properties of the gradient index structure and the surface relief properties of the waveguide substrates to compensate for image distortion and non-uniformity in curved waveguides.

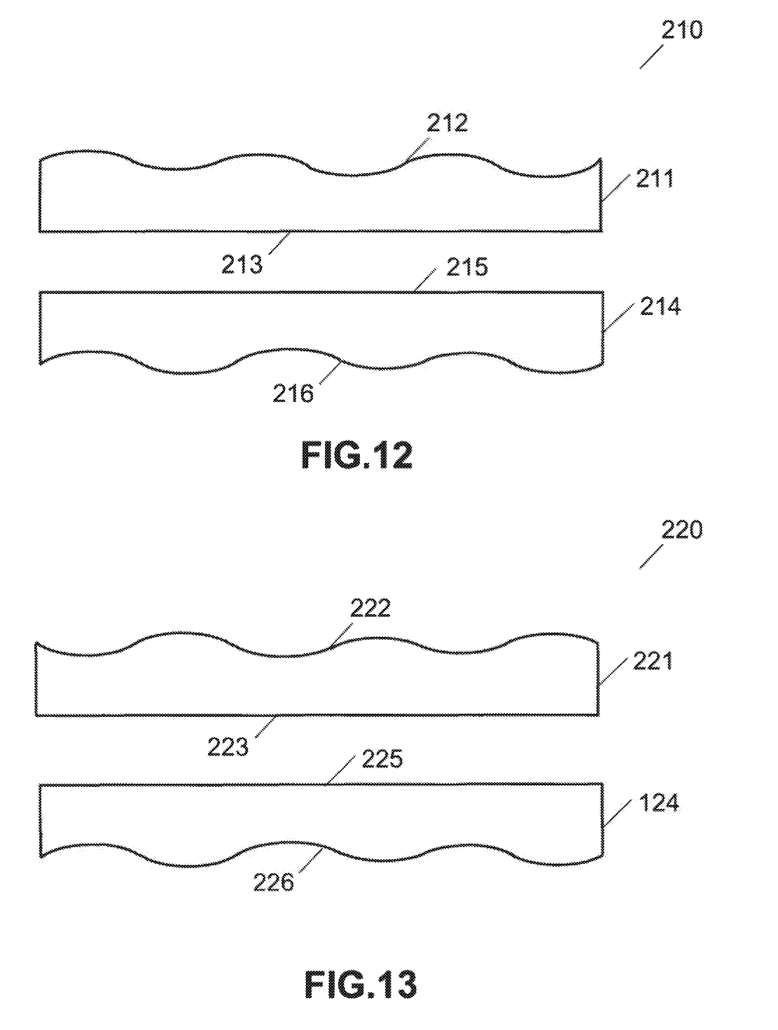

In many embodiments, cancellation of distortions and non-uniformity can be achieved using substrates in which the principal directions of the surface relief characteristics of the substrates first direction and the second direction are parallel. FIG. 12 conceptually illustrates a cross sectional view 210 showing the relative disposition of substrates 211, 214 in a portion of a waveguide in accordance with an embodiment of the invention. In the illustrative embodiment, the surfaces of the substrates in contact with the optical layer (not shown) 213, 215 are planar and the outer surfaces 212, 215 have surface reliefs configured to be in phase along the waveguide. FIG. 13 conceptually illustrates a cross sectional view 220 showing the relative disposition of the substrates in a portion of a waveguide in which the surfaces of the substrates in contact with the optical layer (not shown) 223, 225 are planar and the outer surfaces 222,226 have surface reliefs configured to be displaced by half of a cycle along the waveguide.

### Optical Layer and Gratings

In many embodiments, the optical layer contains at least one grating. In a typical display application, an optical layer can support an input grating, a fold grating for beam steering and vertical beam expansion and an output grating for extraction of light from the waveguide and horizontal beam expansion. Examples of waveguide grating configurations are discussed in detail in the references listed above. In some embodiments, the grating is one of a Bragg grating (also referred to as a volume grating) recorded in a holographic photopolymer or a switchable Bragg grating recorded in a holographic polymer dispersed liquid crystal. Bragg gratings can have high efficiency with little light being diffracted into higher orders. The relative amount of light in the diffracted and zero order can be varied by controlling the refractive index modulation of the grating, a property which can be used to make lossy waveguide gratings for extracting light over a large pupil.

One class of gratings is known as Switchable Bragg Gratings (“SBG”). SBGs can be fabricated by first placing a thin film of a mixture of photopolymerizable monomers and liquid crystal material between parallel glass plates. One or both glass plates can support electrodes, such as but not limited to transparent indium tin oxide films, for applying an electric field across the film. A volume phase grating can then recorded by illuminating the liquid material (often referred to as the syrup) with two mutually coherent laser beams, which can interfere to form a slanted fringe grating structure. During the recording process, the monomers polymerize and the mixture undergoes a phase separation, creating regions densely populated by liquid crystal micro-droplets interspersed with regions of clear polymer. The alternating liquid crystal-rich and liquid crystal-depleted regions form the fringe planes of the grating.

The resulting volume phase grating can exhibit very high diffraction efficiency, which may be controlled by the magnitude of the electric field applied across the film. When an electric field is applied to the grating via transparent electrodes, the natural orientation of the liquid crystal (“LC”) droplets can change, causing the refractive index modulation of the fringes to reduce and the hologram diffraction efficiency to drop to low levels. Typically, SBG elements can be switched clear in 30 μs, with a longer relaxation time to switch ON. The diffraction efficiency of the device can be adjusted by means of the applied voltage over a continuous range. The device can exhibit near 100% efficiency with no voltage applied and essentially zero efficiency with a sufficiently high voltage applied. In certain types of HPDLC devices magnetic fields may be used to control the LC orientation. In certain types of HPDLC, phase separation of the LC material from the polymer can be accomplished to such a degree that no discernible droplet structure results. An SBG can also be used as a non-switching grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The parallel glass plates used to form the HPDLC cell can provide a TIR light guiding structure. Light can be coupled out of the SBG when the switchable grating diffracts the light at an angle beyond the TIR condition. Waveguides are currently of interest in a range of display and sensor applications. Although much of the earlier work on HPDLC has been directed at reflection holograms, transmission devices are investigated as versatile optical system building blocks.

### Manufacturing Processes for Waveguides Implementing Compensation Techniques

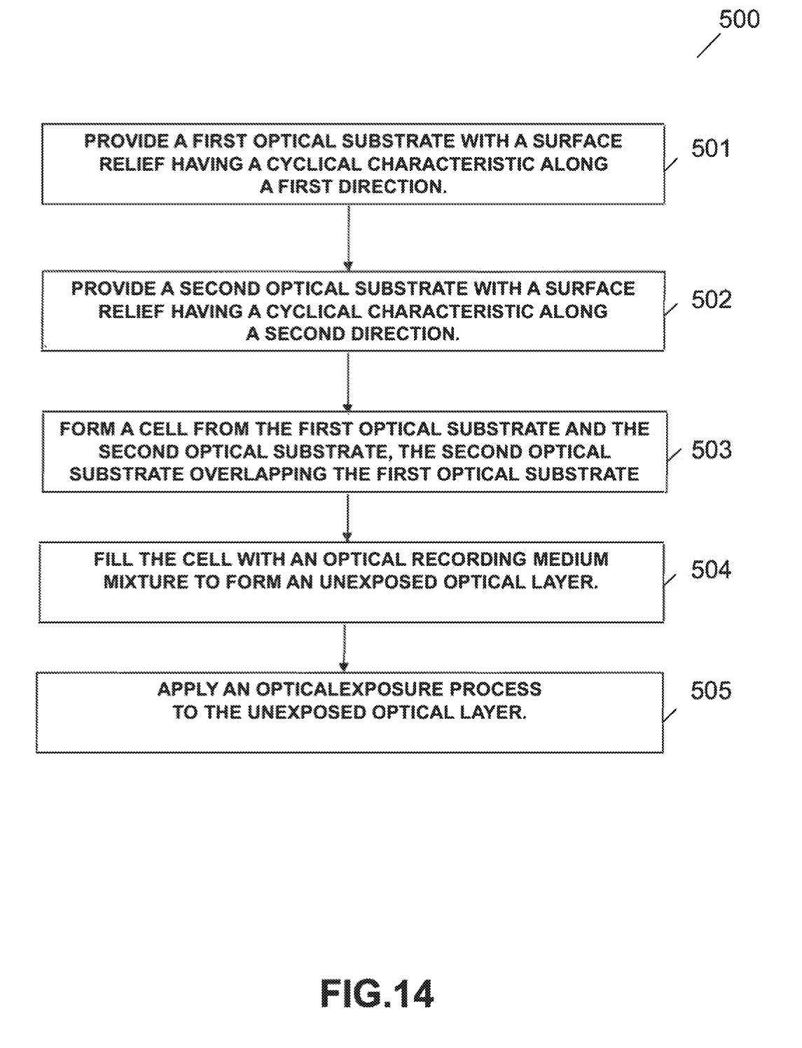

FIG. 14 conceptually illustrates a process 500 for fabricating a waveguide in which the surface relief substrates are formed into a cell and filled with an optical recording medium prior to subjecting the cell to an optical exposure process to form an optical layer. In the illustrative embodiment, a first optical substrate with a surface relief having a cyclical characteristic along a first direction can be provided (501). Correspondingly, a second optical substrate with a surface relief having a cyclical characteristic along a second direction can be provided (502). A cell can be formed (503) from the first optical substrate and the second optical substrate, which can include overlapping the second optical substrate with the first optical substrate. The cell can then be filled (504) with an optical recording medium to form an unexposed optical layer. An optical exposure process can be applied (505) to the unexposed optical layer to form a functional optical layer.

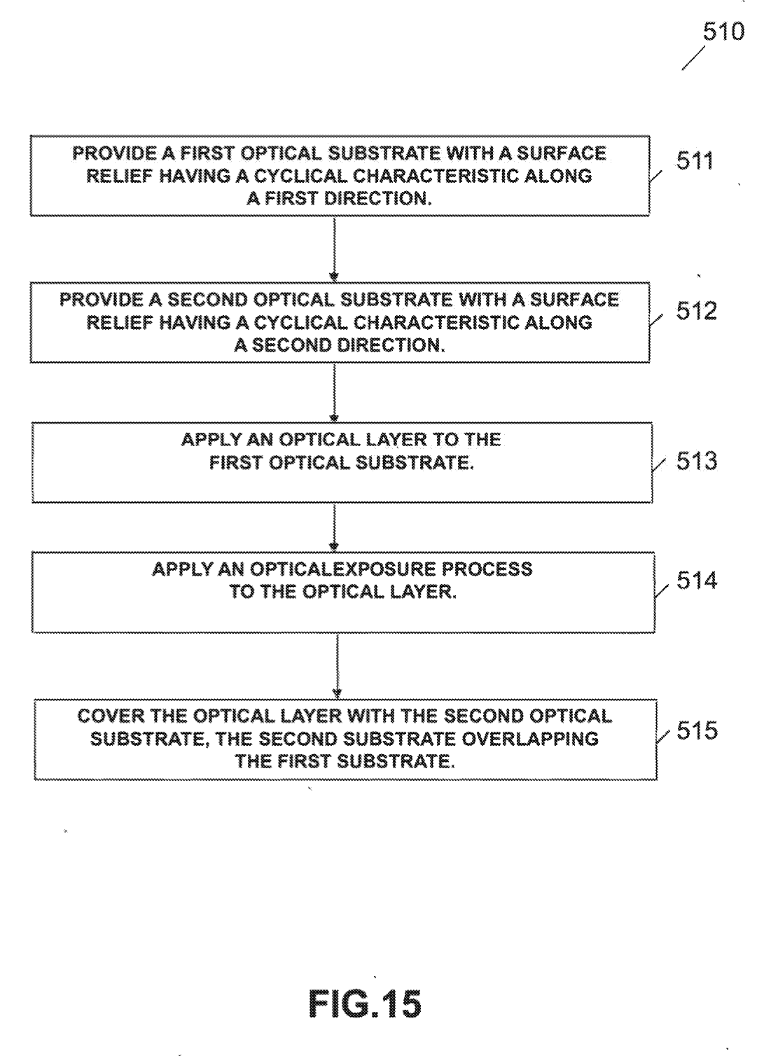

Although FIG. 14 illustrates a specific process for manufacturing a waveguide, any of a number of different manufacturing processes can be utilized in accordance with various embodiments of the invention. FIG. 15 conceptually illustrates another process 510 for fabricating a waveguide in accordance with an embodiment of the invention. In the illustrative embodiment, a first surface relief substrate is coated with an optical recording medium prior to applying an optical exposure process to form an optical layer, which is then covered by a second surface relief substrate. Referring to process 510, a first optical substrate with a surface relief having a cyclical characteristic along a first direction can be provided (511). A second optical substrate with a surface relief having a cyclical characteristic along a second direction can be provided (512). An unexposed optical layer can be applied (513) to the first optical substrate. An optical exposure process can be applied (514) to the unexposed optical layer. The optical layer can then be covered (515) with the second optical substrate, where the second substrate overlaps the first substrate.

In some embodiments, the optical layer is formed into a wedge by tilting one of the substrates. In some embodiments, a wedged optical layer is formed by controlling the layer thickness in a coating process.

In many embodiments, the grating layer can be broken up into separate layers. For example, in some embodiments, a first layer includes the fold grating while a second layer includes the output grating. In some embodiments, a third layer can include the input grating. The number of layers can be laminated together into a single waveguide substrate. In some embodiments, the grating layer includes a number of pieces including the input coupler, the fold grating and the output grating (or portions thereof) that can be laminated together to form a single substrate waveguide. The pieces can be separated by optical glue or other transparent material of refractive index matching that of the pieces. In several embodiments, the grating layer can be formed via a cell making process by creating cells of the desired grating thickness and vacuum filling each cell with optical recording material for each of the input coupler, the fold grating and the output grating. In a number of embodiments, the cell is formed by positioning multiple plates of glass with gaps between the plates of glass that define the desired grating thickness for the input coupler, the fold grating and the output grating. In several embodiments, one cell can be made with multiple apertures such that the separate apertures are filled with different pockets of optical recording material. Any intervening spaces may then be separated by a separating material (e.g., glue, oil, etc.) to define separate areas. In some embodiments, the optical recording material can be spin-coated onto a substrate and then covered by a second substrate after curing of the material. By using a fold grating, the waveguide display can require fewer layers than previous systems and methods of displaying information according to some embodiments. In addition, by using a fold grating, light can travel by total internal refection within the waveguide in a single rectangular prism defined by the waveguide outer surfaces while achieving dual pupil expansion. In another embodiment, the input coupler, the fold grating, and the output grating can be created by interfering two waves of light at an angle within the substrate to create a holographic wave front, thereby creating light and dark fringes that are set in the waveguide substrate at a desired angle. In several embodiments, the grating in a given layer is recorded in stepwise fashion by scanning or stepping the recording laser beams across the grating area. In a number of embodiments, the gratings are recorded using mastering and contact copying process currently used in the holographic printing industry.

In some embodiments in which the waveguide optical layer includes a fold grating, the angular bandwidth of the waveguide can be enhanced by designing the grating prescription to provide dual interaction of the guided light with the grating. Exemplary embodiments of dual interaction fold gratings are disclosed in U.S. patent application Ser. No.: 14/620,969 entitled “WAVEGUIDE GRATING DEVICE.”

In many embodiments, the waveguide further includes a liquid crystal alignment layer. In some embodiments, the waveguide further includes a polarization control layer such as a half wave plate or a quarter waveplate.

Various embodiments of the invention can be used in wide range of waveguide displays including Head Mounted Displays and wearable displays for Augmented Reality and Virtual Reality and waveguide sensors, such as but not limited to eye trackers, fingerprint scanners, and LIDAR systems. In many embodiments, the waveguide provides one of a dynamic focus display or a light field display. In some embodiments, a waveguide according to the principles of the invention can be used in a display using either a laser or LED as a light source and can include one or more lenses for modifying the illumination beam angular characteristics. The image generator can be a micro-display or laser based display. LED can provide better uniformity than laser. If laser illumination is used, there can be a risk of illumination banding occurring at the waveguide output. In several embodiments, laser illumination banding in waveguides can be overcomed using the techniques and teachings disclosed in U.S. patent application Ser. No.: 15/512,500 entitled “METHOD AND APPARATUS FOR GENERATING INPUT IMAGES FOR HOLOGRAPHIC WAVEGU IDE DISPLAYS.”

### Optical Recording Materials

HPDLC mixtures in accordance with various embodiments of the invention generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element comprising: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990 s. Many of these materials use acrylate monomers, including:

R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants;
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator;
Y. H. Cho, et al., Polymer International, 48, 1085-1090, 1999, the disclosure of which is incorporated herein by reference, discloses HPDLC recipes including acrylates;
Karasawa et al., Japanese Journal of Applied Physics, Vol. 36, 6388-6392, 1997, the disclosure of which is incorporated herein by reference, describes acrylates of various functional orders;
T. J. Bunning et al., Polymer Science: Part B: Polymer Physics, Vol. 35, 2825-2833, 1997, the disclosure of which is incorporated herein by reference, also describes multifunctional acrylate monomers; and
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

One of the known attributes of transmission SBGs is that the LC molecules tend to align with an average direction normal to the grating fringe planes (i.e., parallel to the grating or K-vector). The effect of the LC molecule alignment is that transmission SBGs efficiently diffract P polarized light (i.e., light with a polarization vector in the plane of incidence), but have nearly zero diffraction efficiency for S polarized light (i.e., light with the polarization vector normal to the plane of incidence).

In some embodiments, SBGs are recorded in a uniform modulation material, such as POLICRYPS or POLIPHEM having a matrix of solid liquid crystals dispersed in a liquid polymer. The SBGs can be switching or non-switching in nature. In its non-switching form, an SBG has the advantage over conventional holographic photopolymer materials of providing high refractive index modulation due to its liquid crystal component. Exemplary uniform modulation liquid crystal-polymer material systems are disclosed in United State Patent Application Publication No.: US2007/0019152 by Caputo et al and PCT Application No.: PCT/EP2005/006950 by Stumpe et al. both of which are incorporated herein by reference in their entireties. Uniform modulation gratings are characterized by high refractive index modulation (and hence high diffraction efficiency) and low scatter.

In many embodiments, the input coupler, the fold grating, and the output grating can be implemented in a reverse mode HPDLC material. Reverse mode HPDLC differs from conventional HPDLC in that the grating is passive when no electric field is applied and becomes diffractive in the presence of an electric field. The reverse mode HPDLC can be based on any of the recipes and processes disclosed in PCT Application No.: PCT/GB2012/000680, entitled “IMPROVEMENTS TO HOLOGRAPHIC POLYMER DISPERSED LIQUID CRYSTAL MATERIALS AND DEVICES.” The grating can also be recorded in any of the above material systems but used in a passive (non-switching) mode. The fabrication process is typically identical to that used for switched but with the electrode coating stage being omitted. Liquid crystal and polymer material systems are highly desirable in view of their high index modulation. In some embodiments, the gratings are recorded in HPDLC but are not switched.

### Doctrine of Equivalents

While the above description contains many specific embodiments of the invention, these should not be construed as limitations on the scope of the invention, but rather as an example of one embodiment thereof. The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide comprising:
a first substrate having first and second surfaces with a surface relief characteristic along a first direction on at least one of the surfaces of the first substrate;
a second substrate having first and second surfaces with a surface relief characteristic along a second direction on at least one of the surfaces of the second substrate; and
at least one optical layer for modifying at least one of phase, amplitude, and propagation direction of light in contact with the second surface of the first substrate and the first surface of the second substrate, wherein the first and second substrates are configured to confine light to a total internal reflection path.

2. The waveguide of claim 1, wherein the surface relief characteristic of the first substrate comprises a one-dimensional cyclic function.

3. The waveguide of claim 1, wherein the surface relief characteristics of the first and second substrates comprise one-dimensional cyclic functions offset by half a cycle.

4. The waveguide of claim 1, wherein the surface relief characteristics of the first and second substrates comprise one-dimensional cyclic functions in phase.

5. The waveguide of claim 1, wherein the surface relief characteristic of the first substrate comprises at least one sinusoidal frequency.

6. The waveguide of claim 1, wherein the first and second surfaces of the first and second substrates each have a surface relief characteristic described by a one-dimensional cyclic function.

7. The waveguide of claim 1, wherein the first and second substrates are curved.

8. The waveguide of claim 1, wherein the first substrate comprises a rectangular substrate and the first direction is parallel to an edge of the rectangular substrate.

9. The waveguide of claim 1, wherein the first substrate is manufactured using a glass drawing process.

10. The waveguide of claim 1, wherein the first direction and the second direction are separated by ninety degrees.

11. The waveguide of claim 1, wherein the first direction and the second direction are parallel.

12. The waveguide of claim 1, wherein the optical layer forms a wedge.

13. The waveguide of claim 1, wherein the optical layer comprises at least one grating.

14. The waveguide of claim 13, wherein the at least one grating comprises a grating selected from the group consisting of a Bragg grating recorded in a holographic photopolymer and a switchable Bragg grating recorded in a holographic polymer dispersed liquid crystal.

15. The waveguide of claim 1, wherein the waveguide contains a stratified index or gradient index structure.

16. The waveguide of claim 1, further comprising a polarization control layer.

17. The waveguide of claim 1, further comprising a liquid crystal alignment layer.

18. The waveguide of claim 1, wherein the waveguide provides one of a Head Mounted Display a Heads Up Display, an eye-slaved display, a dynamic focus display or a light field display.

19. A method of fabricating a waveguide, the method comprising:
providing a first optical substrate with a surface relief having a cyclical characteristic along a first direction;
providing a second optical substrate with a surface relief having a cyclical characteristic along a second direction;
forming a cell from the first optical substrate and the second optical substrate, wherein the second optical substrate overlaps the second optical substrate;
filling the cell with an optical recording medium to form an unexposed optical layer; and
applying an optical exposure process to the unexposed optical layer.

20. A method of fabricating a waveguide, the method comprising:
providing a first optical substrate with a surface relief having a cyclical characteristic along a first direction;
providing a second optical substrate with a surface relief having a cyclical characteristic along a second direction;
applying an unexposed optical layer to the first optical substrate;
applying an optical exposure process to the unexposed optical layer; and
covering the optical layer with the second optical substrate, wherein the second substrate overlaps the first substrate.
